(19) United States
(12) Patent Application Publication
(10) Pub. No.: US 2020/0249987 A1
(43) Pub. Date: Aug. 6, 2020

(54) ENGINE PRE-EMPTION AND RESTORATION

(71) Applicants: ATI TECHNOLOGIES ULC, Markham (CA); AMD (SHANGHAI) CO., LTD., Shanghai (CN)

(72) Inventors: Yinan JIANG, Markham (CA); Jeffrey G. CHENG, Markham (CA); Kun XUE, Shanghai (CN)

(21) Appl. No.: 16/278,637

(22) Filed: Feb. 18, 2019

(30) Foreign Application Priority Data
Jan. 31, 2019 (CN) 201910098169.8

(51) Int. Cl. G06F 9/48; G06F 9/46; G06F 9/50; G06F 9/54; G06F 9/455

(52) U.S. Cl. CPC G06F 9/4856; G06F 9/461; G06F 9/4812; G06F 2009/4557; G06F 9/544; G06F 9/45558; G06F 9/5077

(57) ABSTRACT

The present disclosure relates to implementing a system for facilitating the migration of virtual machines and corresponding virtual functions from a source host machine to a destination host machine. A source computing device is configured to execute a plurality of virtual machines such that, each of the plurality of virtual machines is associated with at least one virtual function. In response to receiving a migration request, the source computing device is configured to save a state associated with a preempted virtual function for transfer to a destination computing device. The state associated with the preempted virtual function is a subset of a plurality of states associated with the plurality of virtual machines.

### BACKGROUND

### Description of the Related Art

In a virtualized computing environment, the underlying computer hardware is isolated from the operating system and application software of one or more virtualized entities. The virtualized entities, referred to as virtual machines, can thereby share the hardware resources while appearing or interacting with users as individual computer systems. For example, a server can concurrently execute multiple virtual machines, whereby each of the multiple virtual machines behaves as an individual computer system but shares resources of the server with the other virtual machines.

In a virtualized computing environment, the host machine is the actual physical machine, and the guest system is the virtual machine. The host system allocates a certain amount of its physical resources to each of the virtual machines so that each virtual machine can use the allocated resources to execute applications, including operating systems (referred to as “guest operating systems”). The host system can include physical devices (such as a graphics card, a memory storage device, or a network interface device) that, when virtualized, include a corresponding virtual function for each virtual machine executing on the host system. As such, the virtual functions provide a conduit for sending and receiving data between the physical device and the virtual machines. To this end, virtualized computing environments support efficient use of computer resources, but also require careful management of those resources to ensure secure and proper operation of each of the virtual machines.

### BRIEF DESCRIPTION OF THE DRAWINGS

The present disclosure can be better understood, and its numerous features and advantages made apparent to those skilled in the art by referencing the accompanying drawings. The use of the same reference symbols in different drawings indicates similar or identical items.

FIG. 1 is a block diagram of a processing system that includes a source host computing device and graphics processing unit (GPU) in accordance with some embodiments.

FIG. 2 is a block diagram illustrating a migration of a virtual machine from a source host computing device to a destination host computing device in accordance with some embodiments.

FIG. 3 is a block diagram of time slicing system that supports access to virtual machines associated with virtual functions in a processing unit according to some embodiments.

FIG. 4 is a flow diagram illustrating a method for implementing a migration of a virtual machine from a source host GPU to a destination host GPU in accordance with some embodiments.

### DETAILED DESCRIPTION

Part of managing virtualized computing environments involves the migration of virtual machines. Virtual machine migration refers to the process of moving a running virtual machine or application between different physical devices without disconnecting the client or the application. Memory, storage, and network connectivity of the virtual machine are transferred from the source host machine to the destination host machine.

Virtual machines can be migrated both live and offline. An offline migration suspends the guest virtual machine, and then moves an image of the virtual machine's memory from the source host machine to the destination host machine. The virtual machine is then resumed on the destination host machine and the memory used by the virtual machine on the source host machine is freed. Live migration provides the ability to move a running virtual machine between physical hosts with no interruption to service. The virtual machine remains powered on and user applications continue to run while the virtual machine is relocated to a new physical host. In the background, the virtual machine's random-access memory (“RAM”) is copied from the source host machine to the destination host machine. Storage and network connectivity are not altered. The migration process moves the virtual machine's memory, and the disk volume associated with the virtual machine is also migrated. However, existing virtual machine migration techniques save the entire virtual function context and also require re-initialization of the destination host device in order to restore the saved virtual function context. The present disclosure relates to implementing a migration of a virtual machine from a source GPU to a target GPU.

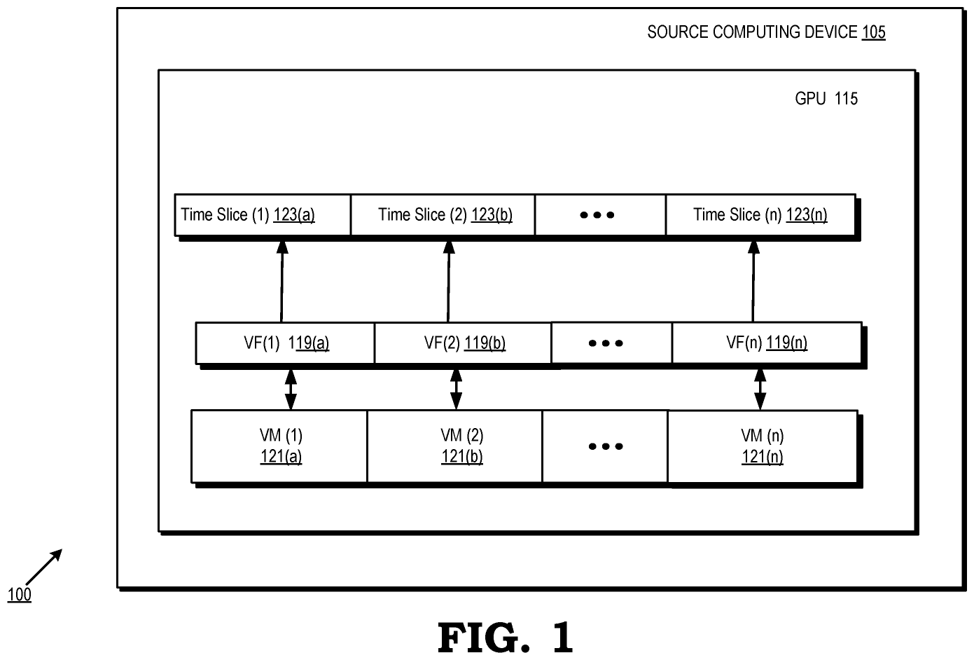

FIG. 1 is a block diagram of a processing system 100 that includes a source computing device 105 and graphics processing unit GPU 115. In some embodiments, the source computing device 105 is a server computer. Alternatively, in other embodiments a plurality of source computing devices 105 are employed that are arranged for example, in one or more server banks or computer banks or other arrangements. For example, in some embodiments, a plurality of source computing devices 105 together constitute a cloud computing resource, a grid computing resource, and/or any other distributed computing arrangement. Such computing devices 105 are either located in a single installation or distributed among many different geographical locations. For purposes of convenience, the source computing device 105 is referred to herein in the singular. Even though the source computing device 105 is referred to in the singular, it is understood that in some embodiments a plurality of source computing devices 105 are employed in various arrangements as described above. Various applications and/or other functionality is executed in the source computing device 105 according to various embodiments.

The GPU 115 is used to create visual images intended for output to a display (not shown) according to some embodiments. In some embodiments the GPU is used to provide additional or alternate functionality such as compute functionality where highly parallel computations are performed. The GPU 115 includes an internal (or on-chip) memory that includes a frame buffer and a local data store (LDS) or global data store (GDS), as well as caches, registers, or other buffers utilized by the compute units or any fix function units of the GPU. In some embodiments, the GPU 115 operates as a physical function that supports one or more virtual functions 119a-119n. The virtual environment implemented on the GPU 115 also provides virtual functions 119a-119n to other virtual components implemented on a physical machine. A single physical function implemented in the GPU 115 is used to support one or more virtual functions. The single root input/output virtualization (“SR IOV”) specification allows multiple virtual machines to share a GPU 115 interface to a single bus, such as a peripheral component interconnect express (“PCI Express”) bus. For example, the GPU 115 can use dedicated portions of a bus (not shown) to securely share a plurality of virtual functions 119a-119n using SR-IOV standards defined for a PCI Express bus.

Components access the virtual functions 119a-119n by transmitting requests over the bus. The physical function allocates the virtual functions 119a-119n to different virtual components in the physical machine on a time-sliced basis. For example, the physical function allocates a first virtual function 119a to a first virtual component in a first-time interval 123a and a second virtual function 119b to a second virtual component in a second, subsequent time interval 123b.

In some embodiments, each of the virtual functions 119a-119n shares one or more physical resources of a source computing device 105 with the physical function and other virtual functions 119a-119n. Software resources associated for data transfer are directly available to a respective one of the virtual functions 119a-119n during a specific time slice 123a-123n and are isolated from use by the other virtual functions 119a-119n or the physical function.

Various embodiments of the present disclosure facilitate a migration of virtual machines 121a-121n from the source computing device 105 to another by transferring states associated with at least one virtual function 119a-119n from a source GPU 115 to a destination GPU (not shown) where the migration of the state associated with at least one virtual function 119a-119n involves only the transfer of data required for re-initialization of the respective one of the virtual functions 119a-119n at the destination GPU. For example, in some embodiments, a source computing device is configured to execute a plurality of virtual machines 121a-121n. In this exemplary embodiment, each of the plurality of virtual machines 121a-121n is associated with at least one virtual function 119a-119n. In response to receiving a migration request, the source computing device 105 is configured to save a state associated with a preempted one of the virtual functions 119a-119n for transfer to a destination computing device (not shown). In some embodiments the state associated with the preempted virtual function 119a is a subset of a plurality of states associated with the plurality of virtual machines 121a-121n.

For example, when a respective one of the virtual machines 121a-121n is being executed on a source computing device 105 associated with a GPU 115 and a migration request is initiated, the GPU 115 is instructed, in response the migration request, to identify and preempt the respective one of the virtual functions 119a-119n executing during the time interval 123a in which the migration request occurred, and save the context associated with the preempted virtual function 119a. For example, the context associated with the preempted virtual function 119a includes a point indicating where a command is stopped prior to completion of the command's execution, a status associated with the preempted virtual function 119a, a status associated with the interrupted command, and a point associated with resuming the command (i.e., information critical for the engine to restart). In some embodiments, the data saved includes location of command buffer in the state of last command being executed, prior to the command's completion, and the metadata location in order to continue once the command is resumed. In some embodiments, this information also includes certain engine states associate with the GPU 115 and the location of other context information.

Once the context information associated with the preempted virtual function 119a is saved and the migration begins, a host driver (not shown) instructs the GPU 115 to extract the saved information (including information such as, for example, context saving area, context associated with the virtual function 119a, engine context). Saved information also includes metadata that was saved into internal SRAM and system memory related to the command buffer and subsequent engine execution information (i.e., information relating to the execution of subsequent commands or instructions for continued execution after resuming the preempted virtual function 119a).

The context information associated with the preempted virtual function 119a is then transferred into the internal SRAM associated with the host destination GPU (not shown). The extracted data is restored iteratively at the destination host GPU. The host performs an initialization to initialize the virtual function 119a at the destination GPU to be in the same state as the host source GPU 115 to be executable. The state associated with the virtual function 119a is restored to the destination host GPU using the extracted data and the GPU engine associated with the destination host GPU is instructed to continue execution from the point at which the virtual function 119a was interrupted. Accordingly, various embodiments of the present disclosure provide migration of states associated with virtual functions 119a-119n from a source GPU 115 to a destination GPU without the requirement of saving entire all contexts associated with each of the virtual functions 119a-119n to memory before migration, thereby increasing migration speed and reducing migration overhead associated with the migration of virtual machines 121a-121n from one host computing device 105 to another.

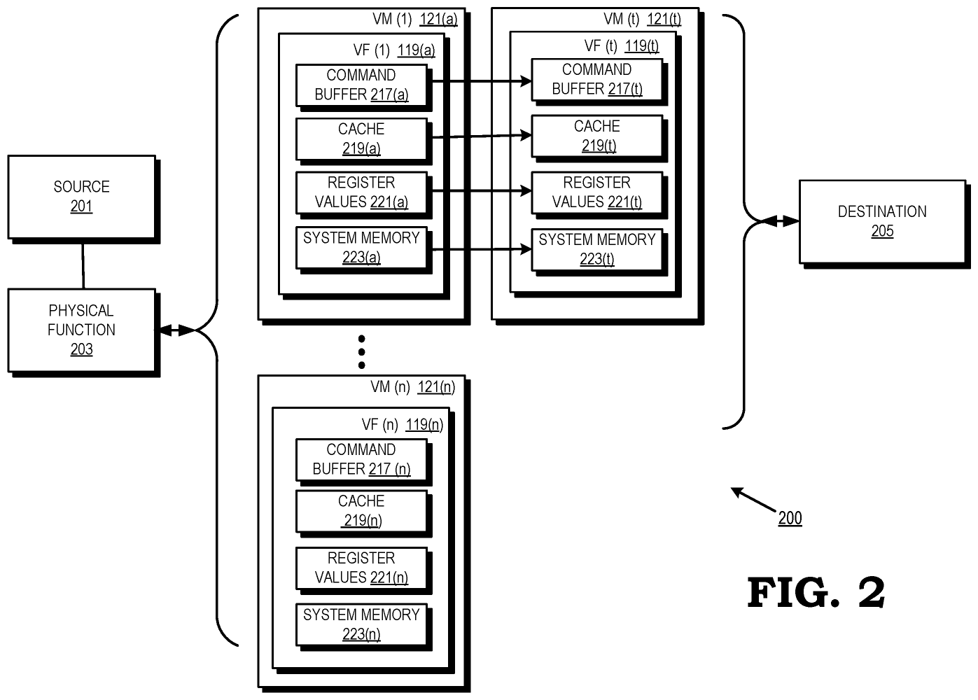

FIG. 2 is a block diagram representation of a migration system 200 that can be implemented to perform a migration of a virtual machine 121a-121n from a source machine 201 to a destination machine 205. The migration system 200 represents a live migration of a respective one of the virtual functions 119a-119n executing in corresponding one of the plurality of virtual machines 121a-121n in accordance some embodiments of the GPU 115 shown in FIG. 1.

The source machine 201 implements a hypervisor (not shown) for the physical function 203. Some embodiments of the physical function 203 support multiple virtual functions 119a-119n. A hypervisor launches one or more virtual machines 121a-121n for execution on a physical resource such as the GPU 115 that supports the physical function 203. The virtual function 119a-119n are assigned to a corresponding virtual machines 121a-121n. In the illustrated embodiment, the virtual function 119a is assigned to the virtual machine 121a, the virtual function 119b is assigned to the virtual machine 121b, and the virtual function 119n is assigned to the virtual machine 121n. The virtual functions 119a-119n then serve as the GPU and provide GPU functionality to the corresponding virtual machines 121a-121n. The virtualized GPU is therefore shared across many virtual machines 121a-121n. In some embodiments, time slicing and context switching are used to provide fair access to the virtual function 119a-119n, as described further herein.

The migration system 200 can detect and extract the command stop point associated with a preempted command. Upon receipt of a migration request, the source GPU is configured to extract a set of information corresponding to the state of the preempted virtual function 119a. For example, when a virtual function 119a is executing and migration is started, the GPU is instructed to preempt the virtual function 119a and save the context of the virtual function 119a at the point of execution corresponding to where the command is paused or interrupted, the status associated with the virtual function 119a, the status of the preempted command, and information associated with resuming an execution of the interrupted command (i.e., information critical for the engine to restart). Saved information also includes metadata that was saved into cache 219 and system memory related to the command buffer 217, register data 221, information in the system memory 223 and subsequent engine execution information (i.e., information relating to the execution of subsequent commands or instructions for continued execution after resuming the preempted virtual function). For example, the saved information can be associated with the interrupted command and a subsequent command. This information is transferred into a memory such as a cache.

Once the data required for resuming the interrupted command associated with the virtual function 119a at the source computing device 201 is saved and the migration is initiated, the host driver instructs the GPU to extract all of the saved information and transfer only the data required to re-initialize the virtual function 119a to the destination machine 205. The destination machine 205 is associated with a corresponding physical function 204. The extracted data is then restored iteratively into the destination machine 205. The destination machine 205 performs an initialization to initialize a virtual function 119t at the destination machine 205 to be in the same state as the source machine 201 to be executable. The virtual function state is restored to the destination machine 205 using the extracted data and a command is issued to the GPU engine to continue execution from the point at which the command associated with the preempted virtual function 119a was interrupted in the source machine 201.

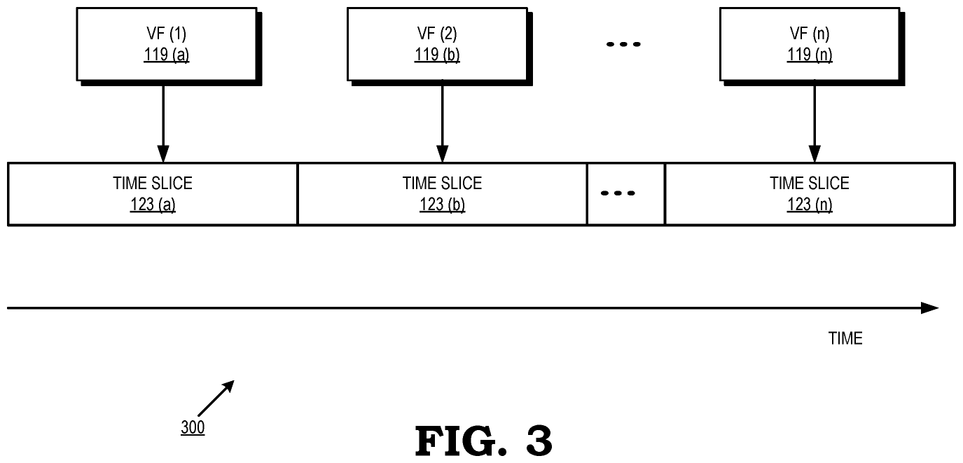

FIG. 3 is a block diagram of time slicing system 300 that supports fair access to virtual functions 119a-119n (FIG. 1) associated with virtual machines 121a-121n (FIG. 1) in a processing unit according to some embodiments. The time slicing system 300 is implemented in some embodiments of the GPU 115 shown in FIG. 1. The time slicing system 300 is used to provide fair access to some embodiments of the virtual functions 119a-119n (FIG. 1). Time increases from left to right in FIG. 3. A first time slice 123a (FIG. 1) is allocated to a corresponding first virtual function, such as the virtual function 119a that is assigned to the virtual machine 121a. Once the first time slice 123a is complete, the processing unit performs a context switch that includes saving current context and state information for the first virtual function to a memory. The context switch also includes retrieving context and state information for a second virtual function from the memory and loading the information into a memory or registers in the processing unit. The second time slice 123b is allocated to the second virtual function 119b, which therefore has full access to the resources of the processing unit for the duration of the second time slice 123b. In some embodiments, a migration request is received from a client over a network performed during a respective one of the time slices 123a-123n. For example, the migration system 200 shown in FIG. 2 is implemented during a time-slice 123n, as discussed herein.

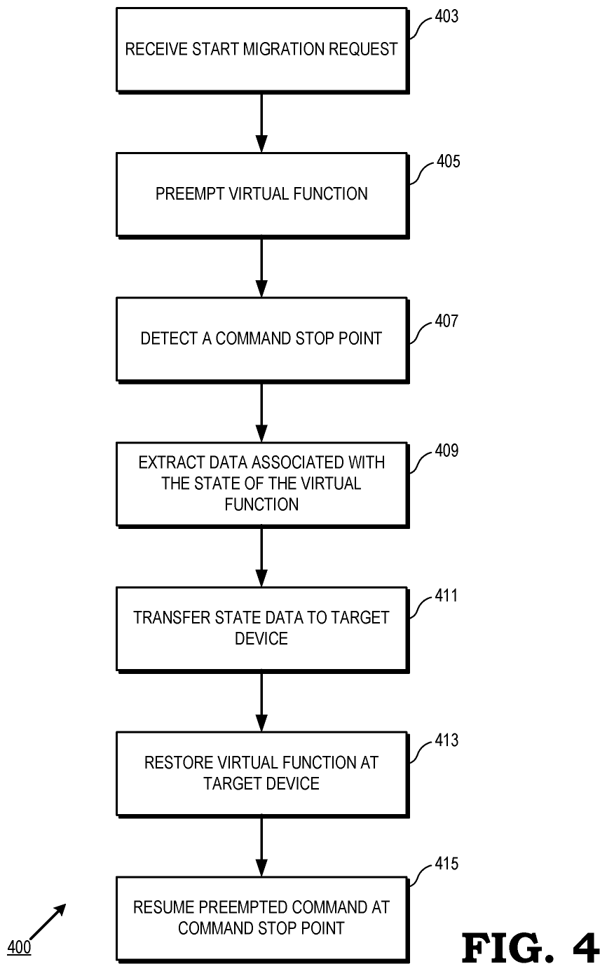

Referring next to FIG. 4, shown is a flowchart that provides one example of the operation of a portion of the migration system 200 (FIG. 2) according to various embodiments. It is understood that the flowchart of FIG. 4 provides merely an example of the many different types of arrangements that are employed to implement the operation of the migration system 200 as described herein. As an alternative, the flowchart of FIG. 4 is viewed as depicting an example of steps of a method implemented in a computing device according to various embodiments.

The flowchart of FIG. 4 sets forth an example of the functionality of the migration system 200 in facilitating a live migration of virtual machines associated with corresponding virtual functions from a source host machine to a destination host machine in accordance with some embodiments. While GPUs are discussed, it is understood that this is merely an example of the many different types of devices that are invoked with the use of the migration system 200. It is understood that the flow can differ depending on specific circumstances. Also, it is understood that other flows are employed other than those discussed herein.

Beginning with block 403, when the migration system 200 (FIG. 2) is invoked to perform a live migration of a virtual machine 121a-121n (FIG. 1) associated with a corresponding virtual function 119a-119n (FIG. 1) at a GPU 115 (FIG. 1) running an engine execution, the GPU is configured to obtain a migration request from a client over a network or local management utility. In response to the migration request, the migration system 200 moves to block 405. In block 405, the GPU is instructed by the host driver to preempt the virtual function 119a and stop execution of a command associated with the virtual function 119a prior to completion of the command's execution. The migration system 200 then moves to block 407. At block 407, the migration system 200 is configured to detect a command stop point. As an example, in response to the migration request, the command's execution could be paused in the middle of the command's execution or some other point prior to the completion of the command's execution. The source GPU 115 is configured to determine the point in the command's execution at which the command was stopped or interrupted. The migration system 200 then moves to block 409. At block 409, once the data required for resuming the interrupted command associated with the virtual function 119a at the source computing device is saved and the migration is initiated, the host driver instructs the GPU to extract all of the saved information including information, such as, for example, context save area (“CSA”), virtual function context, virtual machine context, engine context. Saved information also includes other information such as, for example, metadata that was saved into internal SRAM and system memory relating to subsequent engine execution information (i.e., information relating to the execution of subsequent commands or instructions for continued execution after resuming the preempted virtual function). The migration system 200 then moves to block 411 and transfers only the data required to re-initialize the virtual function 119t to the destination host machine 205 (FIG. 2). At block 413, the extracted data is then restored iteratively into the destination machine 205. The destination host machine 205 (FIG. 2) performs an initialization to initialize a virtual function 119t at the destination host machine 205 to be in the same state as the source host machine 201 to be executable. The virtual function state is restored to the destination host machine 205 using the extracted data. At block 415, the GPU engine instructed to continue execution from the point at which the command associated with the preempted virtual function 119a was interrupted in the source host machine 201.

A computer readable storage medium includes any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium is embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above are implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium are in source code, assembly language code, object code, or other instruction format that is interpreted or otherwise executable by one or more processors.

Note that not all of the activities or elements described above in the general description are required, that a portion of a specific activity or device is not required, and that one or more further activities are performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that cause any benefit, advantage, or solution to occur or become more pronounced are not to be construed as a critical, required, or essential feature of any or all the claims. Moreover, the particular embodiments disclosed above are illustrative only, as the disclosed subject matter can be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above can be altered or modified and all such variations are considered within the scope of the disclosed subject matter. Accordingly, the protection sought herein is as set forth in the claims below.

What is claimed is:

1. A method comprising:
executing a plurality of virtual machines at a source computing device, each of the plurality of virtual machines being associated with at least one virtual function;
in response to receiving a migration request, saving for transfer to a destination computing device, by the source computing device, a first state associated with a preempted virtual function, wherein the first state is a subset of a plurality of states associated with the plurality of virtual machines.

2. The method of claim 1, further comprising detecting, by the source computing device, a command stop point in response to the migration request.

3. The method of claim 2, wherein the command stop point corresponds to a point associated with an interruption of the command.

4. The method of claim 3, further comprising, resuming, by the destination computing device, the execution of the command at the command stop point.

5. The method of claim 1, further comprising identifying, the one of the at least one virtual functions being executed by the one of the plurality of virtual machines at an occurrence of the migration request.

6. The method of claim 1, the first state being limited to a set of data required for resuming the interrupted command associated with the virtual function at the destination computing device.

7. The method of claim 1, further comprising, transferring, from the source computing device to a destination computing device, data associated with a command buffer, data associated with cache a set of register data, and data associated with a system memory.

8. The method of claim 1, further comprising, restoring, by the destination computing device, the one of the plurality of virtual machines, based at least in part on the first state associated with the preempted virtual function.

9. A system comprising:
a network of computing devices, the computing devices including:
a source computing device to host a plurality of virtual machines, wherein the source computing device comprises a physical device including a set of resources allocated to the plurality of virtual machines, wherein a virtual function associated with the physical device is configured for each of the plurality of virtual machines, and further wherein the source computing device is configured to:
extract a set of information corresponding to a state of the virtual function, wherein the state is a subset of states associated with the plurality of virtual machines; and
transfer the set of information to a destination computing device, the destination computing device being configured to:
restore the one of the plurality of virtual machines associated with the virtual function based on the set of information.

10. The system of claim 9, the source computing device being further configured to identify, in response to receiving a migration request, a one of the virtual functions being executed.

11. The system of claim 10, the source computing device being further configured to preempt the identified virtual function.

12. The system of claim 11, the source computing device being further configured to, interrupt, before completion, a processing of an instruction associated with the preempted virtual function.

13. The system of claim 12, further comprising, by the destination computing device an execution of the instruction at an instruction interruption point.

14. The system of claim 13, the set of information being associated with the interrupted instruction and a subsequent instruction.

15. A non-transitory computer readable medium embodying a set of executable instructions, the set of executable instructions to manipulate a processor to:
identify, in response to a migration request, a virtual function being executed by a virtual machine, the virtual machine being one of a plurality of virtual machines associated with a graphics processing unit;
preempt an identified virtual function, in response to receiving the migration request;
interrupt, before completion, a command being executed by the identified virtual function;
detect a command stop point associated with the interrupted command; and
extract a set of information corresponding to a state of the virtual function;
a destination computing device configured to receive the set of information associated with the virtual function from the source computing device; the destination computing device being further configured to:
restore the identified virtual function at the destination computing device based at least in part on the set of information; and
execute the command, wherein the command resumes execution at the command stop point.

16. The non-transitory computer readable medium of claim 15, wherein the command stop point corresponds to a point in the execution at the occurrence of the migration request.

17. The non-transitory computer readable medium of claim 15, wherein transferring further includes:
iteratively transferring data associated with a command buffer, data associated with internal SRAM, a set of register data, and data associated with system memory.

18. The non-transitory computer readable medium of claim 15, wherein the set of information corresponds to data required for resuming the preempted command associated with the virtual function at the destination computing device.

19. The non-transitory computer readable medium of claim 18, the set of information being associated with the interrupted command and a subsequent command.

20. The non-transitory computer readable medium of claim 15, the destination computing device being configured to perform an initialization of the virtual function at the destination computing device, wherein an initial state of the virtual function on the destination computing device is the same as an initial state of the virtual function on the source computing device.
